(19) United States
(12) Patent Application Publication
(10) Pub. No.: US 2011/0031906 A1
(43) Pub. Date: Feb. 10, 2011

(54) MOTOR DRIVING DEVICE, INTEGRATED CIRCUIT DEVICE, MOTOR DEVICE, AND MOTOR DRIVING SYSTEM

(75) Inventors: Masahiro Yasohara, Hyogo (JP); Tomohiro Inoue, Osaka (JP); Kenji Sugiura, Osaka (JP); Toru Tazawa, Osaka (JP); Kenichi Kishimoto, Osaka (JP)

Correspondence Address: Brinks Hofer Gilson & Lione/Panasonic, P.O. Box 10395, Chicago, IL, 60610, US

(73) Assignee: Panasonic Corporation, Kadoma-shi, Osaka (JP)

(21) Appl. No.: 12/936,788

(22) PCT Filed: Mar. 10, 2009
(86) PCT No.: PCT/JP2009/001054

§ 371 Date: Oct. 7, 2010

(30) Foreign Application Priority Data
Apr. 15, 2008 (JP) 2008-105431

(51) Int. Cl. H02P 5/00

(52) U.S. Cl. 318/66

(57) ABSTRACT

A motor driving device according to the present invention includes: a serial communication unit that conducts communication through a serial communication bus, the serial communication bus including a serial data line through which serial data is transmitted and a clock line through which a clock signal is transmitted; and a drive control unit that controls a driving operation of a motor. The motor driving device is configured such that a clock signal received from the serial communication bus is used as a reference clock signal of the drive control unit.

### TECHNICAL FIELD

The present invention relates to a motor driving device suitable to drive a brushless DC motor mounted on an air conditioner, a water heater, an air cleaner, a copying machine, a printer, and the like, an integrated circuit device including the motor driving device, a motor device including the motor driving device, and a motor driving system including the plurality of motor devices. Particularly, the present invention relates to a motor driving device that is controlled by serial communication in which serial data is used, an integrated circuit device including the motor driving device, a motor device including the motor driving device, and a motor driving system including the plurality of motor devices.

### BACKGROUND ART

For example, usually a plurality of motors are mounted on an information instrument such as a copying machine and a laser printer. Recently, in the information instrument that deals with documents, colorization, multiple functions, and high precision are accelerated, and the number of motors mounted on one instrument tends to increase. Therefore, a method for controlling each motor becomes complicated, and the number of signal lines used to control the motors also increases.

Recently, the brushless DC motor is frequently used because of easy rotation control. In a general configuration of the brushless DC motor, a motor body and the motor driving device including a motor driving control circuit are integrated to form the motor device, and the motor driving device and a microcomputer or the like are connected through the signal line to control the motor rotation. At this point, many signal lines for start-up/stop, brake operation/release, normal rotation/reverse rotation, instruction of the number of rotations, monitor of the number of rotations, phase lock detection of the number of rotations, control gain switching and the like are connected between the microcomputer and the motor driving device. Therefore, the number of signal lines increases with increasing number of motors, which results in obstruction of instrument miniaturization due to enlargement of a wiring space, an increase in port load or control load of a main controller such as a microcomputer provided on the instrument side, and an increase of system cost associated therewith.

Recently, in order to suppress the increase of the number of signal lines, a technique of controlling a control target using serial communication is widely adopted in various instruments. In the instrument, the serial communication is realized by connecting the microcomputer and each control target through a serial communication bus. A data bus, which is formed by several signal lines including a serial data line through which serial data is transmitted and a clock line through which a clock signal is transmitted in synchronization with the serial data, is usually used as the serial communication bus. At this point, an identification number such as an address is allocated to the control targets in order to distinguish the control targets from each other. The microcomputer transmits and receives the necessary serial data along with the clock signal while specifying the identification number, which allows data communication to be conducted with each control target. Therefore, various pieces of data can be transmitted and received to and from the plurality of control targets while suppressing the increase of the number of signal lines, and the microcomputer can control each control target using the pieces of data.

A technology in which the serial communication is used is also proposed in the instrument including the plurality of motors.

For example, conventionally there is proposed a driving system for the plurality of motors, in which the serial communication bus is sequentially connected in serial so as to establish cascade connection with respect to the motor driving devices that drive the motors, thereby improving wiring efficiency. For example, Patent Document 1 discloses the contents of the driving system.

The conventional driving system is configured as follows. The pieces of data used to drive the plurality of motors are transmitted as the serial data through the serial communication bus. The motor driving devices each of which is provided in each motor are sequentially connected in serial through the serial communication bus. The address is set to each motor driving device in order to specify the motor driving device using a bit switch or the like. In the plurality of motor driving devices, a first motor driving device receives the data. At this point, the first motor driving device refers to the address transmitted through the serial communication bus, extracts only the data of the first motor driving device transmitted to itself, and stores the extracted data in a register. The first motor driving device transfers the data which is not addressed to itself to the next motor driving device. After that, the processing similar to that of the first motor driving device is performed to control the drive of the plurality of motors. Therefore, with the conventional driving system having such a configuration, the simple configuration can be realized with the small number of lines.

When the control is aimed at the plurality of motor devices like the conventional driving system, because a signal used to determine a rotation speed reference or the like fluctuates among the motor devices, there is a limitation to the enhancement of speed accuracy of each motor device by the simple configuration. Specifically, for example, the number of pulses of an internal clock signal is counted in a pulse period from a speed detector that detects the motor speed, and the counted value is used as a speed detection value. At this point, when a frequency of the internal clock signal fluctuates among the motor devices, a fluctuation in speed is generated in the motor devices.

A specific example in which the fluctuation in speed is generated will be described below. It is assumed that a speed of a standard motor device having an internal clock signal of 1 MHz is controlled such that the number of clocks of the 1-MHz internal clock signal becomes 1000 during the pulse period from the speed detector when an instruction value of 1000 is provided to the standard motor device. That is, it is assumed that the speed control is performed such that the instruction value and the number of clocks are matched with each other. On the other hand, it is assumed that an irregular motor device has the internal clock signal of 1.1 MHz. A speed of the irregular motor device is controlled such that the number of clocks of the 1.1-MHz internal clock signal becomes 1000 during the pulse period from the speed detector when the instruction value of 1000 is also provided to the irregular motor device. That is, for the irregular motor device, the pulse period from the speed detector becomes shorter than that of the standard motor device. In other words, even if the same instruction value of 1000 is provided, the speed of the irregular motor device is controlled so as to rotate at a speed higher than that of the standard motor device. The above-described problem is generated in the conventional motor driving system in which the serial communication is used.

[Patent Document 1] Unexamined Japanese Patent Publication No. 2001-161095

### DISCLOSURE OF THE INVENTION

A motor driving device according to the present invention has the following configuration. The motor driving device includes a serial communication unit that conducts communication through a serial communication bus, the serial communication bus including a serial data line through which serial data is transmitted and a clock line through which a clock signal is transmitted, and a drive control unit that controls a driving operation of a motor. The motor driving device is configured such that a clock signal received from the serial communication bus is used as a reference clock signal of the drive control unit.

The present invention further includes an integrated circuit device including the motor driving device. The present invention further includes a motor device including the motor driving device, a motor, and a speed detector that detects a speed of the motor. The present invention further includes a motor driving system, including the plurality of motor devices and a host device that controls the motor devices, in which the host device and the plurality of motor devices are connected through a serial communication bus.

With this configurations, the present invention can provide the motor driving device, the integrated circuit device, the motor device, and the motor driving system that are able to perform the speed control with high accuracy while achieving the decrease of the number of lines in the instrument on which the motor device is mounted using the serial communication bus.

### BRIEF DESCRIPTION OF THE DRAWINGS

FIG. 1 is a configuration diagram of a motor driving system according to a first embodiment of the present invention.

FIG. 2 is a block diagram illustrating a detailed configuration of a motor device of the motor driving system.

FIG. 3 is a block diagram of a speed control unit of the motor device.

FIG. 4 is a block diagram illustrating another configuration example of the speed control unit of the motor device.

FIG. 5 is a block diagram of a motor device according to a second embodiment of the present invention.

FIG. 6 is a block diagram of an internal clock generating unit of the motor device.

### REFERENCE MARKS IN THE DRAWINGS

10 Host device
11 Serial communication bus
19 Clock oscillator
20 Motor device
21 Motor driving device
22 Integrated circuit device
23 Serial communication unit (communication unit)
24 Parameter setting unit
25 Control unit
26 Driving unit
27 Internal clock generating unit
29 Motor
31 Input processing unit
32 Output processing unit
51 Speed control unit
52 Entire control unit
61 Sine-wave driving unit
62 Inverter
91 Speed detector
92 Position detector
272 Oscillating unit
273 Frequency divider
511 and 271 Phase comparison unit
512 Gain setting unit
513 Waveform shaping unit
514 Clock detecting unit
515 Clock pulse extracting unit
516 Clock cycle measuring unit
517 FG cycle measuring unit
518 Subtractor

### DETAILED DESCRIPTION OF THE PREFERRED EMBODIMENTS

Exemplary embodiments of the present invention will be described below with reference to the drawings.

### First Embodiment

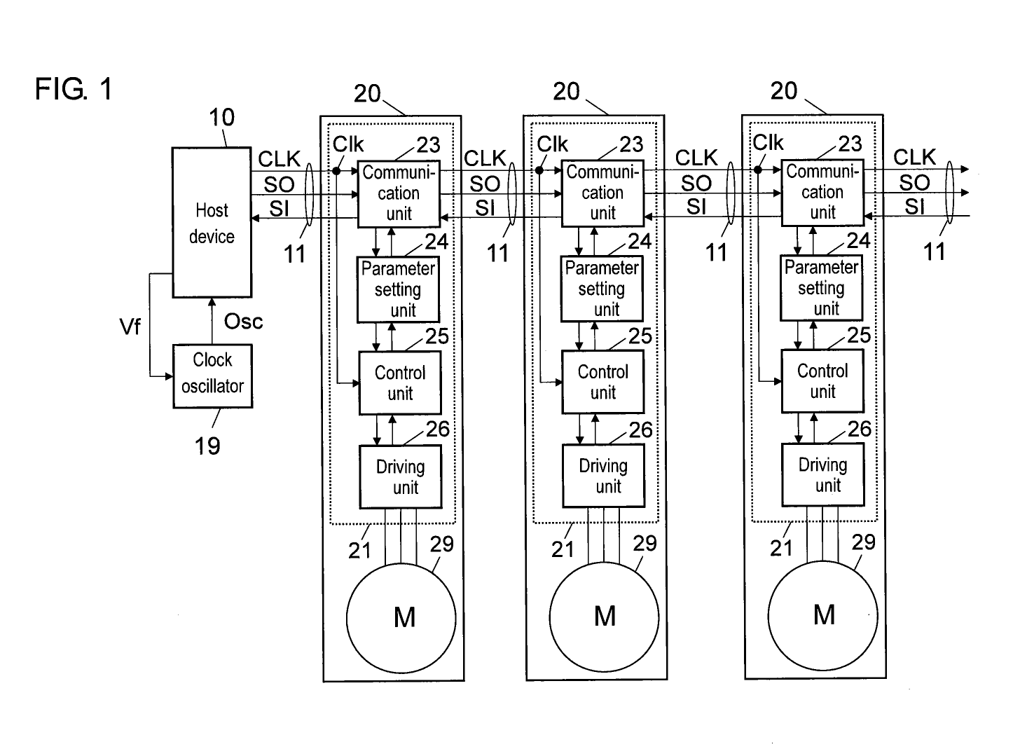

FIG. 1 is a block diagram illustrating a configuration of a motor driving system according to the first embodiment of the present invention.

As illustrated in FIG. 1, in the motor driving system of the present invention, motor device 20 includes motor 29 and motor driving device 21 that control drive of motor 29, and a plurality of motor devices 20 are disposed. The motor driving system includes host device 10 that controls each motor device 20. Host device 10 and motor driving devices 21 of the plurality of motor devices 20 are connected through serial communication bus 11. FIG. 1 illustrates an example in which host device 10 controls three motor devices 20.

For example, host device 10 is included in an instrument on which motor device 20 is mounted, and the host device includes the microcomputer or a DSP (Digital Signal Processor). Host device 10 notifies each motor device 20 through serial communication bus 11 of various pieces of data used to control motor device 20. On the other hand, each motor device 20 notifies host device 10 through serial communication bus 11 of data on the number of rotations of motor 29 and the like.

In the first embodiment, by way of example, serial communication bus 11 includes three signal lines, that is, a data output line SO and a data input line SI, which are of serial data lines through which the serial data is transmitted, and a clock line CLK through which a clock signal Clk is transmitted. The serial data is transmitted from host device 10 to each motor device 20 through the data output line SO. The serial data is transmitted from motor device 20 to host device 10 through the data input line SI. The clock signal Clk that is synchronous with the serial data is transmitted from host device 10 through the clock line CLK.

As illustrated in FIG. 1, clock oscillator 19 is connected to host device 10. Clock oscillator 19 produces the clock signal Clk and an original clock signal Osc that becomes a source to produce timing of the serial data, and supplies the clock signal Clk and the original clock signal Osc to host device 10. Host device 10 produces the clock signal Clk and the serial data using the supplied original clock signal Osc and transmits the produced clock signal Clk and serial data to serial communication bus 11. Clock oscillator 19 produces the original clock signal Osc having a frequency following the control of host device 10. In order to control the frequency, host device 10 supplies an original clock control signal Vf used to control the frequency, to clock oscillator 19.

In the motor driving system of the first embodiment, host device 10 controls the frequency of clock oscillator 19, and the clock signal Clk having the frequency based on the original clock signal Osc controlled by host device 10 is transmitted to serial communication bus 11. With this configuration, not only host device 10 uses the clock signal Clk to transmit the serial data, but also host device 10 uses the clock signal Clk as a reference clock signal in the speed control to transmit the clock signal Clk having the frequency corresponding the speed instructed to motor 29 to the clock line CLK. The serial data is also transmitted as serial data of the timing synchronous with the frequency of the clock signal Clk.

In each motor device 20, motor driving device 21 includes serial communication unit 23 that is connected to serial communication bus 11, parameter setting unit 24 in which various parameters are set to operate motor device 20, control unit 25 that controls the rotation of motor 29, and driving unit 26 that drives motor 29. Hereinafter, serial communication unit 23 is simply referred to as communication unit 23.

The communication units 23 are sequentially connected so as to be in series through serial communication bus 11 from host device 10. In the configuration in which communication units 23 are connected through serial communication bus 11, communication unit 23 conducts the serial communication with host device 10.

Parameter setting unit 24 stores various pieces of data, which are obtained from the serial data transmitted to communication unit 23 through serial communication bus 11, in a storage unit such as a memory while classifying the pieces of data into a control parameter, a driving parameter, and the like. Therefore, the pieces of data such as various parameters are set in parameter setting unit 24.

Control unit 25 performs various kinds of control and processing in motor device 20. For example, parameters such as a control gain from parameter setting unit 24 are set in control unit 25, control unit 25 produces a control signal to control the rotation, and control unit 25 controls rotation operation of motor 29 using the control signal. Driving unit 26 drives motor 29 based on the control signal from control unit 25. Control unit 25 and driving unit 26 constitute a drive control unit that controls the drive of the operation of motor 29.

In motor driving device 21, the clock signal Clk transmitted through the clock line CLK is supplied to control unit 25. As described above, the clock signal Clk is transmitted from host device 10 at the frequency corresponding the speed instructed to motor 29. Therefore, when host device 10 provides the instruction to change the speed to motor driving device 21 through serial communication bus 11, motor driving device 21 uses the clock signal Clk to control the speed of motor 29. One of the features of the first embodiment is that the clock signal Clk is supplied to control unit 25. That is, in the first embodiment, the clock signal Clk is also used as the reference clock signal to control the speed of motor 29.

In the configuration of serial communication bus 11, when host device 10 transmits the serial data along with the clock signal Clk, the clock signal Clk and the serial data are transmitted to communication unit 23 of uppermost motor device 20 that is directly connected to host device 10 through serial communication bus 11. Uppermost communication unit 23 relays the received clock signal Clk and serial data to next-stage communication unit 23. In this way, the serial data is transmitted in order through the data output line SO from host device 10 to uppermost communication unit 23 that is of one end, subsequent communication unit 23, and lowermost communication unit 23 that is of the other end. On the other hand, for the data of which lowermost communication unit 23 notifies host device 10, the serial data is transmitted in order through the data input line SI from lowermost communication unit 23 to preceding communication unit 23, and host device 10.

Host device 10 transmits the clock signal Clk having the frequency corresponding the speed instructed to motor device 20 to the clock line CLK.

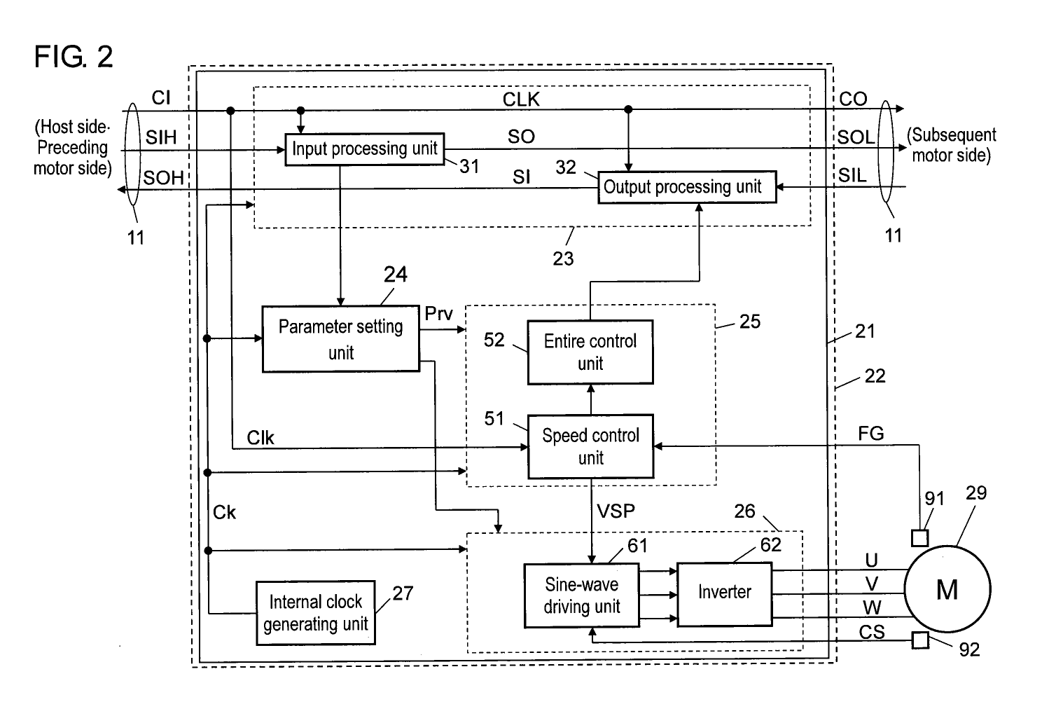

FIG. 2 is a block diagram illustrating a detailed configuration of motor device 20 including motor driving device 21 of the first embodiment of the present invention.

In the configuration illustrated in FIG. 2, motor driving device 21 controls the drive of motor 29. In the first embodiment, by way of example, motor 29 is the brushless DC motor that is driven by motor driving device 21 using a sine wave or a rectangular wave. A part or whole of the function of motor driving device 21 is realized by one or a plurality of integrated circuit devices. FIG. 2 illustrates an example in which the whole of the function of motor driving device 21 is realized by one integrated circuit device 22. A circuit element that realizes the function of motor driving device 21 is formed on a printed board. In motor device 20, the printed board is built in motor 29, or the printed board and motor 29 are integrally formed.

Motor 29 includes a three-phase driving winding (not illustrated) having a U phase, a V phase, and a W phase as a rotor. Driving voltages U, V, and W are supplied to the driving windings from motor driving device 21. Speed detector 91 that detects the speed of motor 29 and position detector 92 that detects a position of the rotor of motor 29 are disposed near motor 29. Speed detector 91 notifies motor driving device 21 of a speed detection signal FG indicating the detected speed. The position detector 92 notifies motor driving device 21 of a position detection signal CS indicating the detected position.

In the brushless DC motor driven by the sine wave, high performance such as reduction of a fluctuation in rotation speed and low-noise/high-efficiency drive is frequently required in a wide rotation speed range. In order to meet the requirements, it is necessary to finely set many control parameters and driving parameters in each rotation speed. When the serial communication bus is used to control the brushless DC motor, various control parameters and driving parameters can finely be set in the speed control and sine-wave drive. Therefore, the control performance and low-noise/high-efficiency driving performance can further be enhanced.

On the other hand, as illustrated in FIG. 2, the clock signal Clk is supplied to a clock input terminal CI of motor driving device 21 through the clock line CLK from host device 10 or the upstream side that is of preceding motor device 20. Serial data is supplied to a data input terminal SIH through the data output line SO. The serial data is outputted to the upstream side through the data input line SI from a data output terminal SOH.

The clock signal Clk from host device 10 is outputted through the clock line CLK to subsequent motor device 20 that is of the downstream side from a clock output terminal CO of motor driving device 21. The serial data from host device 10 is outputted through the data output line SO from a data output terminal SOL. The serial data from subsequent motor device 20 is supplied from the lower side through the data input line SI to a data input terminal SIL.

Communication unit 23 includes input processing unit 31 that performs processing of the serial data supplied to the data input terminal SIH and output processing unit 32 that performs processing of notifying host device 10 of the serial data.

Input processing unit 31 takes in the serial data supplied to the data input terminal SIH according to the clock signal Clk supplied to the clock input terminal CI. Input processing unit 31 performs parallel conversion of the taken-in serial data and takes in the parallel conversion data as input data. Input processing unit 31 refers to address information included in the input data and determines whether the input data is data sent to itself. When determining that the input data is the data sent to itself, input processing unit 31 transfers the data to parameter setting unit 24.

The data of which output processing unit 32 notifies host device 10 is supplied to output processing unit 32 from control unit 25. Output processing unit 32 converts the data of which output processing unit 32 notifies host device 10 along with address data thereof into the serial data, and output processing unit 32 transmits the converted serial data to host device 10 according to the clock signal Clk supplied to the clock input terminal CI. Output processing unit 32 relays the serial data supplied to the data input terminal SIL, and outputs the serial data from the data output terminal SOH. Thus, output processing unit 32 performs processing of transferring the serial data transmitted from the downstream side to host device 10.

Parameter setting unit 24 includes a setting memory in which, for example, the parameter set from host device 10 is stored. Input processing unit 31 stores pieces of data for setting various operations in the setting memory. Examples of the pieces of data stored in the setting memory include control operation setting data for setting a control operation, driving operation setting data for setting a driving operation, power unit operation setting data for setting an operation of a power unit such as an inverter, start-up delay setting data for setting delay time during the start-up, protective operation setting data for setting protective operation, successive operation setting data for setting successive operations, and energy saving setting data for setting an operation related to energy saving. Examples of the control operation setting data include data related to a control parameter such as a control gain corresponding to the rotation speed and data indicating a detection range of rotation information indicating that the rotation speed reaches the instructed rotation speed. Examples of the driving operation setting data include data indicating an advance angle value corresponding to the rotation speed, data indicating a waveform driving motor 29, and data indicating a pulse width modulation method. Examples of the power unit operation setting data include data indicating dead time, data indicating the frequency of the pulse width modulation, data indicating switching speed of a power transistor. The protective operation setting data include data indicating validity/invalidity of the protective function and data indicating parameter setting such as an operation threshold. Examples of the successive operation setting data include data instructing the successive operation, for example, “start-up→rotation at desired speed→deceleration by braking→stop→restart”.

Control unit 25 includes speed control unit 51 that performs the control related to the rotation speed of motor 29 and entire control unit 52 that performs the control and processing of each unit of motor device 20. Entire control unit 52 performs processing related to a basic operation of motor device 20, processing of a feedback request to ask host device 10 for transmitting data, and the like through output processing unit 32.

Speed control unit 51 takes in each piece of data that is of the control parameter from the driving operation setting data stored in parameter setting unit 24. Therefore, the control parameter for the rotation control such as the control gain necessary to produce a speed control signal VSP is set in speed control unit 51. Speed control unit 51 produces the speed control signal VSP while the control parameter is set, and speed control unit 51 controls the rotation speed of motor 29 using the produced speed control signal VSP.

Driving unit 26 includes sine-wave driving unit 61 and inverter 62. Sine-wave driving unit 61 produces a sine-wave driving signal used to perform sine-wave drive of motor 29 according to the speed control signal VSP from speed control unit 51. Inverter 62 supplies the driving voltage U, V, and W to the driving windings of motor 29 based on the sine-wave driving signal. Sine-wave driving unit 61 includes a Pulse Width Modulation (PWM) circuit that produces the sine-wave driving signal. Inverter 62 converts DC power into AC driving power by the driving signal from sine-wave driving unit 61 and drives motor 29.

The sine-wave driving unit 61 produces a sine-wave signal having amplitude corresponding to the speed control signal VSP from speed control unit 51 and a phase corresponding to the position detection signal CS from the position detector 92. Sine-wave driving unit 61 produces a driving pulse signal in which pulse width modulation is performed by the produced sine-wave signal. The produced driving pulse signal is supplied as the sine-wave driving signal to inverter 62.

Inverter 62 converts the DC power into the AC driving power and produces the driving voltages U, V, and W used to drive motor 29. Therefore, inverter 62 outputs the pulsed driving voltages U, V, and W according to the sine-wave driving signal. The sine-wave driving signal is a signal in which the pulse width modulation is performed by the sine-wave signal. Therefore, according to a pulse width modulation principle, the driving voltages U, V, and W that become the sine-wave voltage in an average value according to the sine-wave signal are supplied to the driving windings.

Internal clock generating unit 27 generates an internal clock signal Ck for digital processing in motor driving device 21 and supplies the internal clock signal Ck to each unit of motor driving device 21. For example, the internal clock signal Ck is used in a reference clock pulse of the pulse width modulation in sine-wave driving unit 61.

In the first embodiment, the clock signal Clk is supplied to speed control unit 51 of control unit 25 from the clock line CLK. That is, motor driving device 21 of the first embodiment takes in the clock signal Clk transmitted from host device 10 as a speed instruction signal of the frequency corresponding to the speed instructed to motor 29, thereby controlling the speed of motor 29.

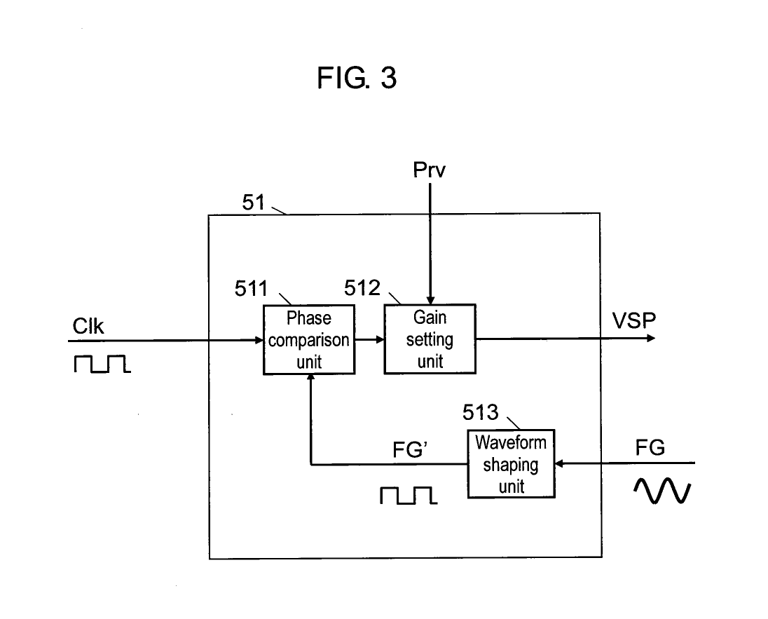

FIG. 3 is a block diagram illustrating a detailed configuration of speed control unit 51. As illustrated in FIG. 3, speed control unit 51 includes waveform shaping unit 513. Waveform shaping unit 513 shapes the waveform of the speed detection signal FG from speed detector 91 and outputs the shaped signal as a speed detection signal FG′. Speed control unit 51 includes phase comparison unit 511. Phase comparison unit 511 compares the phase of the clock signal Clk that is of the speed instruction signal and the phase of the speed detection signal FG′ from waveform shaping unit 513, and phase comparison unit 511 outputs a phase comparison signal. Speed control unit 51 includes gain setting unit 512. A control parameter Pry from parameter setting unit 24 is set in gain setting unit 512, and gain setting unit 512 performs control gain processing to the phase comparison signal from phase comparison unit 511.

In the configuration of speed control unit 51 illustrated in FIG. 3, phase comparison unit 511 outputs the phase comparison signal corresponding to a phase difference between the phase of the clock signal Clk transmitted from host device 10 and the phase of the speed detection signal FG′. Gain setting unit 512 performs proper gain processing to the phase comparison signal, and gain setting unit 512 outputs the speed control signal VSP. Driving unit 26 drives motor 29 such that motor 29 is rotated at the speed corresponding to the speed control signal VSP. The rotation speed is detected by speed detector 91 and fed back as the speed detection signal FG′ to phase comparison unit 511 through waveform shaping unit 513. Alternatively, frequency comparison may be performed instead of the phase comparison, performed by phase comparison unit 511, of the clock signal Clk and the speed detection signal FG′. Using the feedback loop, speed control unit 51 controls motor 29 such that motor 29 is rotated at the speed corresponding to the frequency of the clock signal Clk transmitted from host device 10.

Thus, in the first embodiment, not only the clock signal Clk is used in the serial data transmission, but also the clock signal Clk is used as the reference clock signal in the speed control. Therefore, for the motor driving system of the first embodiment in which the plurality of motor devices 20 are driven, the speed accuracy of each motor device 20 is stabilized, and a speed difference between motor devices 20 can be suppressed.

For example, occasionally the clock signal Clk differs largely from the speed detection signal FG in the frequency such that the normal frequency of the clock signal Clk is 1 MHz while the frequency of the speed detection signal FG is 10 KHz at the maximum rotation speed. When the clock signal Clk is higher than the speed detection signal FG in the frequency, the frequency of the clock signal Clk may be divided. On the other hand, when the clock signal Clk is lower than the speed detection signal FG in the frequency, the frequency of the clock signal Clk may be multiplied. That is, the clock signal Clk from the clock line CLK is supplied to the frequency divider or multiplier, and the signal in which the frequency of the clock signal Clk is divided or multiplied may be supplied as the speed instruction signal to phase comparison unit 511 of FIG. 3.

A configuration in which a frequency dividing ratio used to divide the clock signal Clk or a frequency multiplying factor used to multiply the clock signal Clk is set through serial communication bus 11 may further be added. Particularly, for the motor driving system of the first embodiment in which the plurality of motor devices 20 are controlled, the rotation speed range can be set in each motor device 20 in the above-described configuration. In the configuration in which the frequency of the clock signal Clk is divided, the frequency of the clock signal Clk is set relatively higher than the frequency of the speed detection signal FG, so that a transmission rate of the serial communication can be enhanced without constraining the speed setting of motor 29. In the configuration in which the frequency of the clock signal Clk is multiplied, the frequency of the clock signal Clk is set relatively lower than the frequency of the speed detection signal FG, so that a risk of a communication error of the serial communication can be reduced without constraining the speed setting of motor 29.

A technique of transmitting the clock signal Clk only in a period during which the serial data is transmitted is widely used in serial communication bus 11. In the configuration, the clock signal Clk is not continuously transmitted. That is, the clock pulses having the same cycle, for example, tens pulses are transmitted only when the serial data is transmitted, and the transmission is paused in other periods. The clock signal Clk is intermittently transmitted.

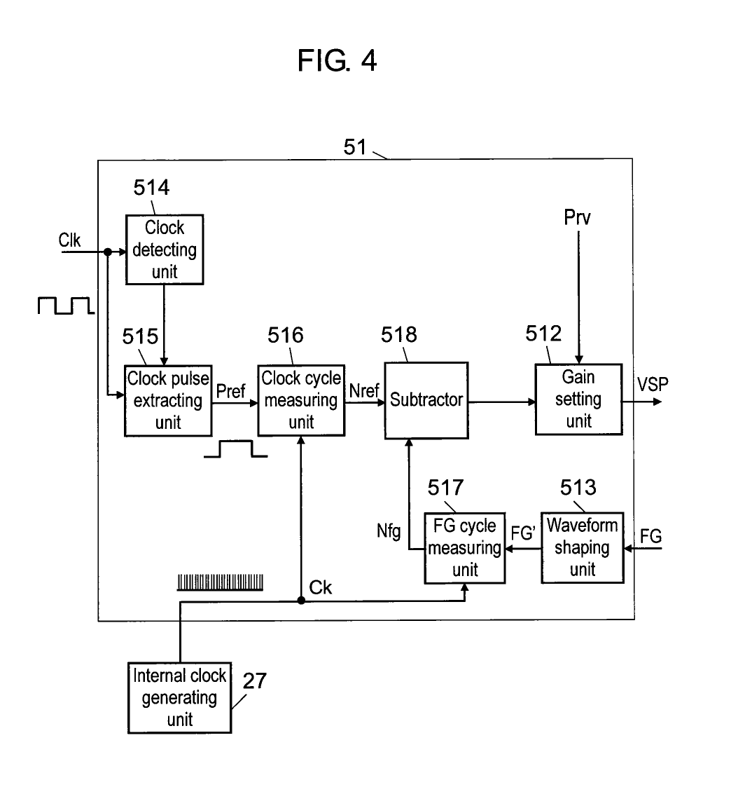

FIG. 4 is a block diagram illustrating another configuration example of speed control unit 51 that is suitable to serial communication bus 11 through which the clock signal Clk is intermittently transmitted.

In FIG. 4, clock detecting unit 514 detects that the clock signal Clk is transmitted from host device 10. When clock detecting unit 514 detects the transmission of the clock signal Clk, correspondingly clock pulse extracting unit 515 extracts the pulse from the clock signal Clk to detect a period of the extracted pulse. For example, an extraction pulse Pref that becomes a period from the rising of the pulse to the next rising is output with respect to the pulse of the clock signal Clk.

The extraction pulse Pref from clock pulse extracting unit 515 and the internal clock signal Ck from internal clock generating unit 27 are supplied to clock cycle measuring unit 516. Clock cycle measuring unit 516 counts the number of pulses of the internal clock signal Ck in the pulse period of the extraction pulse Pref. Clock cycle measuring unit 516 outputs the counted number of pulses as a speed instruction value Nref corresponding to the speed instruction signal. Clock cycle measuring unit 516 stores the measured result as a cycle measured value therein.

On the other hand, FG cycle measuring unit 517 detects a period from the rising of the pulse of the speed detection signal FG′ to the next rising and measures the number of pulses of the internal clock signal Ck in the pulse period. FG cycle measuring unit 517 outputs the measured number of pulses as a speed detection value Nfg corresponding to the speed detection signal.

Subtractor 518 performs a difference operation between the speed instruction value Nref and the speed detection value Nfg and outputs the operation result as a speed deviation value. Gain setting unit 512 sets a proper gain with respect to the speed deviation value and outputs the gain as the speed control signal VSP.

Thus, the speed instruction signal can be formed using the pulse period of the clock signal Clk and the internal clock signal Ck. With this configuration, because the speed instruction signal can be produced based on at least one pulse of the clock signal Clk, the configuration of FIG. 4 can also be applied to the case in which the clock signal Clk is intermittently transmitted from host device 10. Alternatively, the plurality of extraction pulses Pref are produced from the plurality of pulses of the clock signal Clk, and an average value of the detected speed instruction values Nref may be set to the speed instruction signal.

Particularly, speed control unit 51 is configured as illustrated in FIG. 4, whereby the following effect is exerted when the plurality of motor devices 20 are controlled like the motor driving system of the first embodiment.

Because usually internal clock generating unit 27 included in motor device 20 is a simple oscillator, the internal clock signal Ck has low frequency accuracy. Therefore, a fluctuation in frequency is generated in the internal clock signals Ck of the plurality of motor devices 20. On the other hand, when speed control unit 51 of motor device 20 is configured as illustrated in FIG. 4, the speeds of motor devices 20 are controlled by the pulse cycle of the clock signal Clk that is common among motor devices 20. Therefore, even if the fluctuation in frequency is generated among the internal clock signals Ck of motor devices 20, because the fluctuation can be absorbed, the fluctuation in speed among motor devices 20 can be suppressed. Because the simple oscillator such as a CR oscillator may be used as internal clock generating unit 27, it is not necessary to provide an expensive quartz oscillator.

The case in which one of motor devices 20 has the internal clock signal of 1 MHz while the other motor device 20 has the internal clock signal of 1.1 MHz is cited as a specific example in which the fluctuation in motor devices 20 is absorbed. For the motor of 1000 rotations per second, it is assumed that, due to the fluctuation in internal clock signal, one of motor devices 20 has the speed detection value Nfg of 1000 while the other motor device 20 has the speed detection value Nfg of 1100. When the cycle of the extraction pulse Pref based on the pulse cycle of the clock signal Clk is set to 1 ms that indicates the instruction of 1000 rotations, the speed instruction value Nref of one of motor devices 20 becomes 1000 while the speed instruction value Nref of the other motor device 20 becomes 1100. As a result, although motor devices 20 differs from each other in the speed detection value Nfg and the speed instruction value Nref, motor devices 20 are rotated at the number of rotations corresponding to the instruction of 1000 rotations, that is, at the rotation speed. Thus, clock cycle measuring unit 516 measures the cycle of the clock signal Clk using the internal clock signal Ck, and the measured result is used as the speed instruction signal, so that the difference in speed among motor devices 20 can be suppressed even if the simple oscillator is used as internal clock generating unit 27. Additionally, because the clock signal Clk can be paused, a control load on host device 10 can be reduced. Motor driving device 21 is configured such that the take-in or storage of the cycle of the clock signal Clk can be controlled by the instruction of host device 10. Therefore, a degree of freedom of the communication rate can be improved, because host device 10 can specialize the clock signal Clk for the serial communication while motor driving device 21 can flexibly deal with the intermittently transmitted clock signal Clk.

As described above, motor driving device 21 includes the communication unit 23 that conducts the communication through serial communication bus 11 including the serial data line through which the serial data is transmitted and the clock line CLK through which the clock signal Clk is transmitted, and motor driving device 21 drives motor 29. Motor driving device 21 includes control unit 25 that controls the driving operation of motor 29 and driving unit 26, and the clock signal Clk received from serial communication bus 11 is used as the reference clock signal that is of the speed reference.

The speed control unit 51 that produces the speed control signal VSP based on the speed instruction signal and the speed detection signal FG produces the speed instruction signal using the clock signal Clk received from serial communication bus 11.

The speed instruction signal is the clock signal Clk, and the speed control unit 51 produces the speed control signal VSP based on the phase comparison of the speed instruction signal that is of the clock signal Clk and the speed detection signal FG.

Therefore, according to the motor driving device, integrated circuit device, motor device, and motor driving system of the first embodiment, the motor speed can be controlled based on the frequency and cycle of the clock signal of the serial communication bus. That is, the clock signal of the serial communication bus can be used as the reference clock signal for the speed control, and the speed control can be realized with the simple circuit while performed with high accuracy when the plurality of motor devices are controlled.

Further, the cycle measured value measured by the clock cycle measuring unit 516 illustrated in FIG. 4 can be used as follows. The cycle measured value is a value indicating a degree of the fluctuation in internal clock signal Ck based on the clock signal Clk. Therefore, the deviation from the standard, caused by the fluctuation in internal clock signal Ck in driving unit 26, can also be corrected using the cycle measured value. The settings, related to the time in which the internal clock signal Ck is used, such as the delay time of the start-up time specified by the parameter setting, the setting time of the protective operation, the frequency setting of the pulse width modulation, and the dead time are corrected using the cycle measured value, which allows the accuracy of each driving operation of driving unit 26 to be enhanced in the drive control unit.

The configuration in which the speed control unit produces the speed control signal based on the speed instruction signal and the speed detection signal is described above by way of example. Alternatively, the speed control unit may simply produce the speed control signal based on the speed instruction signal. That is, the clock signal, the signal whose the frequency of the clock signal is divided, or the signal whose the frequency of the clock signal is multiplied may be used as the speed control signal. Alternatively, the cycle of the clock signal Clk is measured using the internal clock signal Ck, and the measured result may be used as the speed control signal. The control method for directly driving the motor is adopted in fan motor drive for the air conditioner, the water heater on which a burning fan motor is mounted, the air cleaner, and the like, so that the present invention can also be applied when the plurality of motors are used in the instruments.

As described above, the present invention has the configuration in which the clock signal received from the serial communication bus is used as the reference clock signal of the motor driving device. Accordingly, the motor driving device that is able to perform the speed control with high accuracy while achieving the decrease of the number of lines in the instrument on which the motor device is mounted using the serial communication bus, the integrated circuit device, the motor device, and the motor driving system can be provided.

Recently, in the motor used in the document instruments, the high performance such as the reduction of the fluctuation in rotation speed and the low-noise/high-efficiency drive is required in the wide rotation speed range. According to the present invention, the many control parameters and driving parameters are finely set in each rotation speed using the serial communication. Therefore, the present invention can meet the requirements.

### Second Embodiment

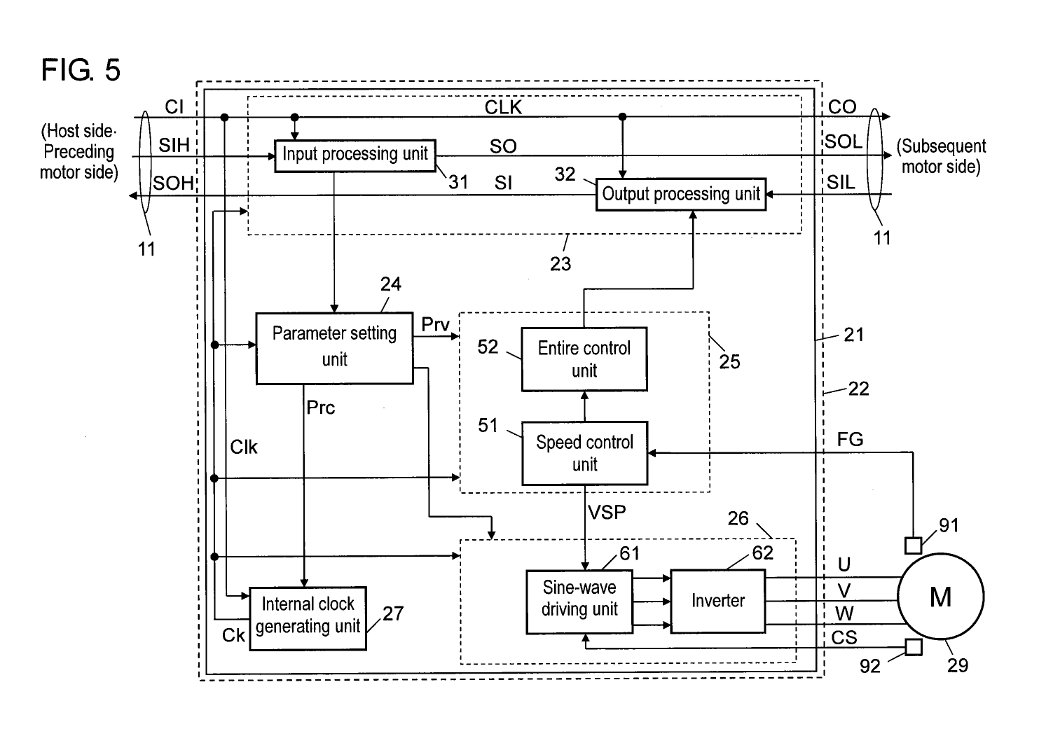

FIG. 5 is a block diagram illustrating configuration of a motor driving device according to a second embodiment of the present invention.

As illustrated in FIG. 5, motor driving device 21 of the second embodiment differs from the motor driving device of the first embodiment in that the clock signal Clk transmitted through the clock line CLK is supplied to internal clock generating unit 27. Parameter setting unit 24 notifies internal clock generating unit 27 of a parameter Prc related to the generation of the internal clock. The same components as those of the first embodiment are designated by the same numerals, and the detailed description thereof is omitted.

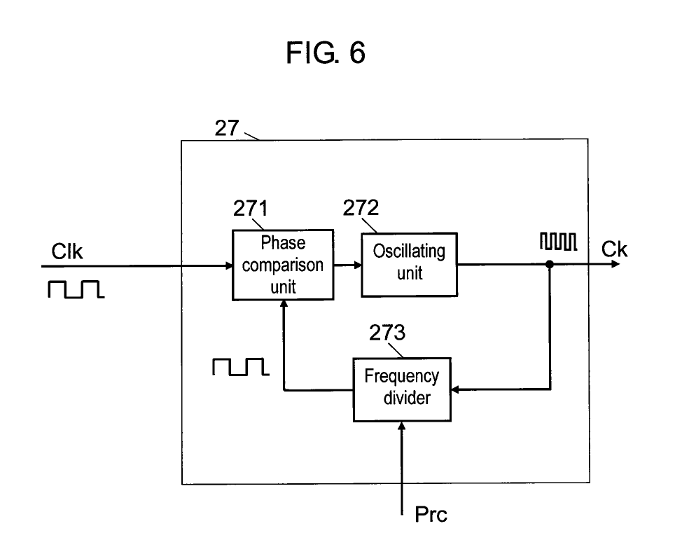

FIG. 6 is a block diagram illustrating a detailed configuration of internal clock generating unit 27 of the second embodiment. A configuration of motor driving device 21 of the second embodiment will be described below with reference to FIGS. 5 and 6.

As illustrated in FIG. 6, internal clock generating unit 27 includes frequency divider 273 that divides the frequency of the internal clock signal Ck and phase comparison unit 271 that performs the phase comparison of the clock signal Clk transmitted to the clock line CLK and an output signal of frequency divider 273. Parameter setting unit 24 notifies frequency divider 273 of the frequency dividing ratio of frequency divider 273 as the parameter Prc, and the frequency dividing ratio is set in frequency divider 273. Internal clock generating unit 27 includes oscillating unit 272 that produces the internal clock signal Ck having the frequency corresponding to the phase control by the phase control that is performed so as to obtain the frequency corresponding to the output signal of phase comparison unit 271. Thus, internal clock generating unit 27 constitutes a Phase Lock Loop (PLL) that locks the internal clock signal Ck in the clock signal Clk. In the PLL configuration, internal clock generating unit 27 acts as the multiplier, and outputs the internal clock signal Ck whose frequency is higher than that of the clock signal Clk according to the frequency dividing ratio of frequency divider 273. At this point, the multiplying factor is set as follows. The frequency dividing ratio of frequency divider 273 is set through serial communication bus 11 or parameter setting unit 24, thereby properly setting the multiplying factor.

That is, in motor driving device 21 of the second embodiment, the internal clock signal Ck supplied to control unit 25 and the drive control unit that is of driving unit 26 is produced based on the clock signal Clk received from serial communication bus 11. Thus, in motor driving device 21 of the second embodiment, the internal clock signal Ck is regenerated based on the clock signal Clk and used as the reference clock signal of motor driving device 21.

Motor driving device 21 of the second embodiment has the above-described configuration, so that the internal clock signal Ck having the accuracy equal to that of clock oscillator 19 included in host device 10 can be obtained. For example, when the plurality of motor devices 20 are driven as illustrated in FIG. 1, internal clock generating unit 27 of each motor device 20 is synchronized with the clock signal Clk from host device 10, so that the accuracy of the internal clock signal Ck can be equalized among motor devices 20. Therefore, the troubles such as the fluctuation in speed among motor devices 20 can be suppressed.

For example, in motor devices 20 constituting the motor driving system, even if the fluctuation is generated such that one of internal clock generating units 27 of motor devices 20 has a free-running frequency of 1 MHz while the other internal clock generating unit 27 has a free-running frequency of 1.1 MHz, the frequencies of the internal clock signals Ck outputted from internal clock generating units 27 are matched with each other by locking the free-running frequencies in the frequency of the clock signal Clk. Therefore, the fluctuation in speed can also be suppressed among motor devices 20.

The accuracy of settings, related to the time in which the internal clock signal Ck is used, such as the delay time of the start-up time specified by the parameter setting, the setting time of the protective operation, the frequency setting of the pulse width modulation, and the dead time can be enhanced because the frequency accuracy of the internal clock signal Ck can be enhanced.

The motor driving device of the second embodiment is configured to have the multiplying function of regenerating the internal clock signal Ck from the clock signal Clk. Alternatively, the clock signal Clk may be used as the internal clock signal Ck, or the signal in which the frequency of the clock signal Clk is divided may be used as the internal clock signal Ck. When the frequency of the clock signal Clk is divided, the clock signal Clk is supplied to frequency divider 273, and the divided output may be used as the internal clock signal Ck. Alternatively, the clock signal Clk may obviously be outputted as the internal clock signal Ck through a buffer or an amplifier.

The configuration in which clock cycle measuring unit 516 of FIG. 4 is used may be used as the technique of producing the internal clock signal Ck with the clock signal Clk. That is, the clock cycle measuring unit that measures the cycle of the clock signal Clk and stores the measured result as the cycle measured value therein is included and internal clock generating unit 27 generates the internal clock signal Ck of the cycle corresponding to the cycle measured value. Alternatively, the take-in or storage of the cycle of the clock signal Clk may be further controlled by the instruction of host device 10. Any configuration in which the internal clock signal Ck is produced using the clock signal Clk may be used.

### INDUSTRIAL APPLICABILITY

In the motor driving device, motor device, motor driving system of the present invention, the speed control can be performed with high accuracy while the number of limes in the instrument on which the motor device is mounted, and the many control parameters and driving parameters can finely be set in each rotation speed using serial communication. Therefore, the present invention is suitable to the motor driving system and motor device, used in the printer, the copying machine, and the information instruments such as a hard disk and an optical medium device, in which the high performance is required in the wide rotation range. The present invention is also suitable to the fan motor drive for the air conditioner, the water heater on which the burning fan motor is mounted, the air cleaner, and the like.

1. A motor driving device that drives a motor, comprising:
a serial communication unit that conducts communication through a serial communication bus, the serial communication bus including a serial data line through which serial data is transmitted and a clock line through which a clock signal is transmitted; and
a drive control unit that controls a driving operation of the motor, wherein
the clock signal received from the serial communication bus is used as a reference clock signal of the drive control unit.

2. The motor driving device according to claim 1, wherein
the drive control unit includes a speed control unit that produces a speed control signal for controlling a speed of the motor based on a speed instruction signal that provides an instruction of a speed of the motor and a speed detection signal from a speed detector that detects the speed of the motor, and
the drive control unit produces the speed instruction signal that becomes a speed instruction reference using the clock signal received from the serial communication bus.

3. The motor driving device according to claim 2, wherein
the speed control unit produces the speed control signal based on one of phase comparison of the speed instruction signal and the speed detection signal, and frequency comparison of the speed instruction signal and the speed detection signal.

4. The motor driving device according to claim 1, wherein
the drive control unit includes a speed control unit that produces a speed control signal for controlling a speed of the motor based on a speed instruction signal that provides an instruction of a speed of the motor, and
the drive control unit produces the speed instruction signal that becomes a speed instruction reference using the clock signal received from the serial communication bus.

5. The motor driving device according to claim 2, wherein
the speed instruction signal is used as a clock signal.

6. The motor driving device according to claim 2, wherein
the speed instruction signal is used as a signal in which a frequency of the clock signal is divided.

7. The motor driving device according to claim 6, wherein
a frequency dividing ratio used to divide the frequency of the clock signal is set through the serial communication bus.

8. The motor driving device according to claim 2, wherein
the speed instruction signal is multiplied is used as a signal in which the clock signal.

9. The motor driving device according to claim 8, wherein
a multiplying factor used to multiple the clock signal is set through the serial communication bus.

10. The motor driving device according to claim 2, further comprising:
an internal clock generating unit that produces an internal clock signal; and
a clock cycle measuring unit that measures a cycle of the clock signal and stores the measured result as a cycle measured value therein, wherein
the clock cycle measuring unit measures the cycle of the clock signal using the internal clock signal and supplies the measured result to the drive control unit.

11. The motor driving device according to claim 10, wherein
the result measured by the clock cycle measuring unit is supplied as the speed instruction signal to the speed control unit.

12. The motor driving device according to claim 10, wherein
instructions to measure and store the cycle of the clock signal are provided through the serial communication bus.

13. The motor driving device according to claim 1, wherein
the clock signal received from the serial communication bus or a signal regenerated from the clock signal is used as an internal clock signal that is a reference clock signal of the drive control unit.

14. The motor driving device according to claim 1, wherein
the clock signal received from the serial communication bus is multiplied, and the signal in which the clock signal is multiplied is used as an internal clock signal that is a reference clock signal of the drive control unit.

15. The motor driving device according to claim 14, wherein
a multiplying factor used to multiply the clock signal is set through the serial communication bus.

16. The motor driving device according to claim 1, further comprising:
an internal clock generating unit that generates an internal clock signal; and
a clock cycle measuring unit that measures a cycle of the clock signal and stores the measured result as a cycle measured value therein, wherein
the internal clock generating unit generates an internal clock signal having a cycle corresponding to the cycle measured value, and the generated internal clock signal is used as a reference clock signal of the drive control unit.

17. The motor driving device according to claim 16, wherein
instructions to measure and store the cycle of the clock signal are provided through the serial communication bus.

18. The motor driving device according to claim 1, further comprising:
an internal clock generating unit that produces an internal clock signal having a phase according to phase control; and
a phase comparison unit that performs phase comparison of the clock signal and the internal clock signal and outputs a phase comparison signal, wherein
the internal clock generating unit is controlled such that a phase of the clock signal and a phase of the internal clock signal are matched with each other based on the phase comparison signal, and
the internal clock signal is used as a reference clock signal of the drive control unit.

19. An integrated circuit device comprising the motor driving device according to claim 1.

20. A motor device comprising:
a motor;
a speed detector that detects a speed of the motor; and
the motor driving device according to claim 1.

21. A motor driving system comprising:
the plurality of motor devices according to claim 20; and
a host device that controls the motor device, wherein
the host device and the plurality of motor devices are connected through the serial communication bus.
